(19) United States
(12) Patent Application Publication
(10) Pub. No.: US 2024/0425046 A1
(43) Pub. Date: Dec. 26, 2024

(54) METHOD FOR DETERMINING A MAXIMUM END SPEED

(71) Applicant: Robert Bosch GmbH, Stuttgart (DE)

(72) Inventor: Florian Ott, Weinsbreg (DE)

(21) Appl. No.: 18/707,953

(22) PCT Filed: Oct. 24, 2022
(86) PCT No.: PCT/EP2022/079626

§ 371 Date: May 7, 2024

(30) Foreign Application Priority Data
Nov. 8, 2021 (DE) 10 2021 212 517.4

(51) Int. Cl. B60W 30/14

(52) U.S. Cl. CPC B60W 30/143; B60W 2555/60; B60W 2720/103

(57) ABSTRACT

A method for determining a maximum end speed of a motor vehicle before the start of a speed limit area. The method includes determining a current motor vehicle speed, a speed limit value of an upcoming speed limit area, and a distance to the start of the speed limit area. A time is estimated to the speed limit area on the basis of the previously determined values. A speed increase with respect to the current motor vehicle speed is determined, dependent on the time to the speed limit area. A deceleration is estimated, so that based on the current motor vehicle speed, the speed increase, and the distance to the start of the speed limit area, the speed limit value is present at the start of the speed limit are. The determined speed increase is reduced if the estimated deceleration is greater than a deceleration limit value.

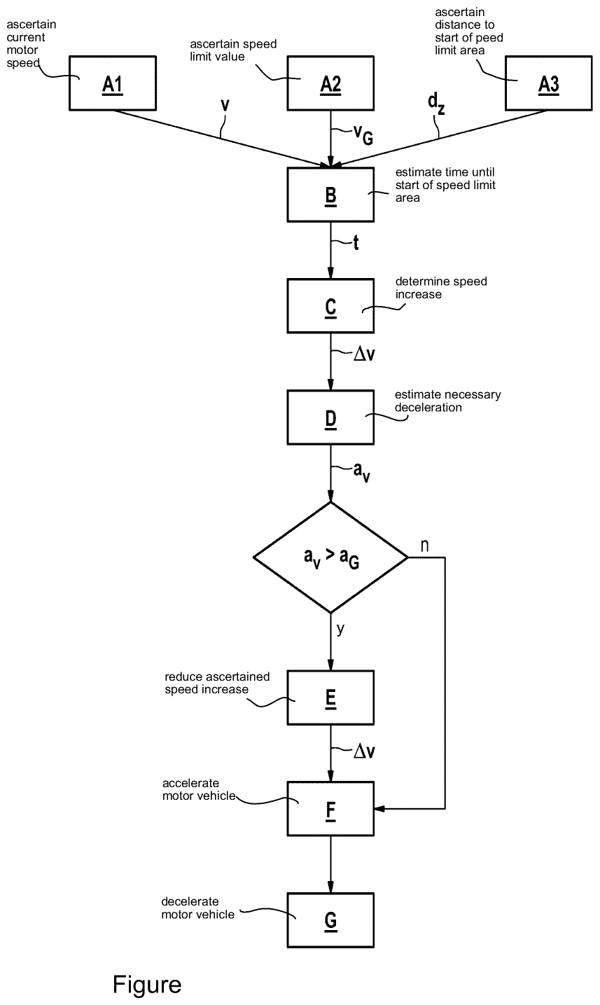

### FIELD

The present invention relates to a method for ascertaining a maximum end speed of a motor vehicle before the start of a speed limit area. The present invention also relates to a control unit for carrying out the method.

### BACKGROUND INFORMATION

Automated driving functions are increasingly being offered in modern vehicles to relieve the driver, for example freeway or parking assistants or also, in future, piloted functions. Such functions can also control longitudinal control, i.e., acceleration or deceleration of the vehicle.

German Patent Application No. DE 10 2009 058 393 A1 describes a method for automatically changing a cruise control speed from a current speed zone to the next speed zone. A point at which the maximum permitted speed of the zone changes from the current maximum permitted speed to the next maximum permitted speed is ascertained in front of a moving vehicle. A speed profile is ascertained in order to change the vehicle speed from the current maximum permitted speed to the next maximum permitted speed. The speed profile comprises non-linear changes in vehicle speed between the current speed zone and the next speed zone to eliminate abrupt changes in vehicle speed.

The problem now is when a traffic sign appears a little further away and the ego vehicle is not at the maximum permitted speed. How much and for how long the ego vehicle has to accelerate in order to avoid braking again unnecessarily at the traffic sign, for example, but also to avoid driving slowly for too long.

An object of the present invention is therefore to provide a method that calculates an ideal target speed in order to avoid accelerating unnecessarily or to avoid driving unnecessarily slowly before an area with a speed limit value.

To achieve the object, a method for ascertaining a maximum end speed of a motor vehicle before the start of a speed limit area is provided according to the present invention. Furthermore, a control unit for a driver assistance system with a computing unit for carrying out the method is provided according to the present invention. Preferred embodiments of the present invention are disclosed herein.

### SUMMARY

The present invention provides a method for ascertaining a maximum end speed of a motor vehicle before the start of a speed limit area. The speed limit area is an area in which the vehicle should drive at a speed lower than the maximum end speed. This lower speed, which is referred to below as the speed limit value, can result from safety aspects or legal regulations. The maximum end speed is the maximum speed to which the motor vehicle can be accelerated before the speed limit area.

According to an example embodiment of the present invention, to ascertain this maximum speed, a current motor vehicle speed, the speed limit value of an upcoming speed limit area and a distance to the start of the speed limit area are ascertained first. Based on these values, a time to the speed limit area is estimated. It is thus estimated approximately how long it will take the motor vehicle to reach the start of the speed limit area. A speed increase with respect to the current motor vehicle speed is then ascertained, which is dependent on the time to the speed limit area. This speed increase is preferably calculated using an algorithm that is dependent on the motor vehicle. The speed increase corresponds to a differential speed between the current motor vehicle speed and the maximum end speed. Adding the current speed and the speed increase thus gives the maximum end speed.

In the next step, a deceleration is estimated so that, on the basis of the current motor vehicle speed, the speed increase and the distance to the start of the speed limit area, the speed limit value is present at the start of the speed limit area. The ascertained speed increase is reduced if the estimated deceleration is greater than a deceleration limit value. The deceleration limit value can be predefined or varied by the driver within certain limits. It is also possible to reduce the deceleration limit value depending on the road conditions, such as snow or rain.

An advantage of this method of the present invention is that it can be carried out using simple calculations, thus reducing the computing power required to carry out the method. In addition, unnecessary braking and acceleration is avoided. This can save fuel. Safety is also increased, since the deceleration is kept within a predefined range. Using this method as part of a driver assistance system also increases driving comfort for the driver.

In a preferred embodiment of the present invention, the speed increase is read out from a characteristic map. In this characteristic map, a value for a speed increase can be stored for the time to the speed limit area, for example. Such a characteristic map can be stored by the manufacturer, for example. The use of such a characteristic map considerably simplifies the ascertainment of the speed increase. This makes the method quicker and easier to carry out. In addition, the computing capacity can again be significantly reduced.

In a further preferred embodiment of the present invention, the reduction of the ascertained speed increase is calculated using a characteristic map for the estimated deceleration. A speed reduction value for the ascertained deceleration can be stored in such a characteristic map. A factor between zero and one can also be stored in the characteristic map. In this case, the speed increase is multiplied by this factor to ascertain a resulting speed increase. This allows a resulting speed increase to be ascertained quickly and easily. The use of a characteristic map considerably simplifies the calculations for this too.

Preferably, the characteristic maps are selected according to a selected driving mode of the motor vehicle. In this case, the driver can choose between different driving modes, such as a sport mode or a fuel-saving mode. Accordingly, a corresponding characteristic map stored for carrying out the method is used. In contrast to a sport mode, the speed increase and correspondingly the deceleration is lower in a fuel-saving mode. The method can thus be adapted to the driver's wishes, significantly improving driving comfort.

In an advantageous development of the present invention, a constant deceleration is assumed in order to estimate the deceleration. It is therefore assumed that the motor vehicle decelerates with a constant deceleration value, starting from the maximum end speed. Although a constant deceleration is not normally performed, the use of a constant deceleration makes it easier to estimate the deceleration. This again significantly reduces the computing complexity.

Alternatively, according to an example embodiment of the present invention, a predefined deceleration function is used for the deceleration. These deceleration functions are based on real decelerations. By using such deceleration functions, the deceleration can be determined much more precisely. In addition, a maximum occurring deceleration value can be better predicted.

In another advantageous embodiment of the present invention, the distance to the start of the speed limit area is ascertained using map data and/or sensor data and/or cloud data. Based on the current position, which is ascertained via GPS, for example, the distance to the start of the speed limit area can be ascertained within the map. The distance to the speed limit area can also be ascertained using a radar sensor, for example. Such a sensor is already installed in many cars for other assistance systems, and therefore no additional sensor is required. In addition or as an alternative to this, the distance can also be ascertained based on GPS data from a cloud. Thanks to these possibilities, a distance to a speed limit area can be ascertained easily and economically.

According to an expedient embodiment of the present invention, the speed limit value is ascertained on the basis of legally prescribed limit values and/or road-section-dependent limit values. A legally prescribed limit value is, for example, a speed restriction or another speed specified for a certain area. This speed restriction can be indicated by signs, for example. The limit value can also be defined, for example, by a bend, a slope, or the condition of the road.

According to another expedient embodiment of the present invention, the speed limit value is ascertained using map data and/or camera data and/or cloud data. The speed limit value can be ascertained on the basis of values stored in the map. A speed limit value can also be ascertained on the basis of a course of a section of road recognized on the map, such as a bend. In this case, the bend radius or a maximum bend radius of a bend can be defined in the map. The speed limit value is then defined on the basis of this bend radius. It can be ensured thereby that braking does not have to be carried out unnecessarily in the bend, which increases safety. The speed limit values of the legal and also road-section-dependent limit values can also be retrieved from a cloud. This can reduce the computing power of such a system.

Advantageously, according to an example embodiment of the present invention, once the maximum end speed has been ascertained, the motor vehicle is accelerated from the current speed to this speed and then decelerated to the speed limit value until the start of the speed limit area. These steps, provided as part of a driver assistance system, relieve the driver of work, thereby increasing driving comfort.

The object of the present invention is additionally solved by a control unit for a driver assistance system for controlling a longitudinal control of a motor vehicle, having a computing unit for carrying out the method according to the present invention. Such a control unit can thus be integrated into a motor vehicle so that the advantages described for the method can be achieved.

The method according to the present invention described above can, for example, in particular be computer-implemented and thus embodied in software. The present invention therefore also relates to a computer program comprising machine-readable instructions that, when executed on one or more computers, cause the computer or computers to carry out the described method. In this sense, control devices for vehicles and embedded systems for technical devices, which are also capable of executing machine-readable instructions, are also to be regarded as computers.

The present invention also relates to a machine-readable data carrier and/or to a download product comprising the computer program. A download product is a digital product that can be transmitted via a data network, i.e., can be downloaded by a user of the data network, and can, for example, be offered for immediate download in an online shop.

Exemplary embodiments of the present invention are illustrated in the FIGURE and explained in more detail in the following description.

### BRIEF DESCRIPTION OF THE DRAWING

The FIGURE shows an exemplary embodiment of a method according to the present invention.

### DETAILED DESCRIPTION OF EXAMPLE EMBODIMENTS

The FIGURE shows an exemplary embodiment of a method according to the present invention. This method is used to ascertain a maximum end speed vₘₐₓ of a motor vehicle before the start of a speed limit area. In a first step A1, the current motor vehicle speed v is ascertained first. This speed v is ascertained directly from the current values of the motor vehicle, for example. The speed v can also be determined using the values of the GPS system.

In the first step A2, a speed limit value v_{G} of an upcoming speed limit area is also ascertained. The speed limit value v_{G} can be determined on the basis of legal values. The speed limit value v_{G} can also be ascertained via a speed limit sign detected by a camera of the motor vehicle. The speed limit value v_{G} can also be ascertained using speed limit values v_{G} entered in a map. In addition, a speed limit value v_{G} can be ascertained from the map using the bend radius, for example.

In the first step A3, a distance d_{Z} to the start of the speed limit area is also ascertained. The distance d_{Z} can be determined from map data in the same way as the speed limit value v_{G}. Alternatively or additionally, this distance d_{Z} can be ascertained using sensors of the motor vehicle, such as a radar sensor.

In the next step B, a time t until the start of the speed limit area is estimated on the basis of the current motor vehicle speed v, the speed limit value v_{G} and the distance d_{Z} to the start of the speed limit area. The time t can be calculated using the formula t=d_{Z}/((v_{G}+v)/2), for example. Since the time t is calculated on the basis of the current speed v, this is only an estimate.

In the next step C, a speed increase Δv is determined on the basis of the time t. For this purpose, a speed increase Δv for time t is ascertained using a characteristic map, for example. Subsequently, in step D, a necessary deceleration a_{V} is estimated on the basis of this speed increase Δv, so that the speed limit value v_{G} is present at the start of the speed limit area. To estimate the deceleration a_{V}, a constant deceleration can be assumed, so that the deceleration a_{V} results from the following formula: a_{V}=(v_{G}−v²)/(2*d_{Z}). Alternatively, the deceleration a_{V} can also be ascertained using a characteristic map.

The deceleration a_{V} ascertained in this way is compared with a deceleration limit value a_{G}. This deceleration limit value a_{G} represents a maximum deceleration that has been determined, for example, on the basis of driving comfort, the technical requirements of the motor vehicle or the road conditions. If the ascertained deceleration a_{V} is greater than the deceleration limit value a_{G}, the ascertained speed increase Δv is reduced in the next step E. The magnitude of the reduction can be ascertained from a characteristic map, for example.

After the speed increase Δv has been reduced, or if the deceleration ay does not exceed the deceleration limit value a_{G}, the motor vehicle is accelerated in a next step F to the end speed vₘₐₓ resulting from the motor vehicle speed v and the speed increase Δv. In a subsequent step G, the motor vehicle is then decelerated to the speed limit value v_{G} until the start of the speed limit area.

1-13. (canceled)

14. A method for ascertaining a maximum end speed of a motor vehicle before a start of a speed limit area, comprising the following steps:
ascertaining a current motor vehicle speed, a speed limit value of an upcoming speed limit area, and a distance to the start of the speed limit area;
estimating a time to the speed limit area based on the current motor vehicle speed, the speed limit, and the distance to the start of the speed limit area;
determining a speed increase with respect to the current motor vehicle speed, the increase being dependent on the time to the speed limit area;
estimating a deceleration so that, based on the current motor vehicle speed, the speed increase, and the distance to the start of the speed limit area, the speed limit value is present at the start of the speed limit area; and
reducing the ascertained speed increase when the estimated deceleration is greater than a deceleration limit value.

15. The method according to claim 14, wherein the speed increase is read out from a characteristic map.

16. The method according to claim 14, wherein the reduction of the ascertained speed increase is calculated using a characteristic map for the estimated deceleration.

17. The method according to claim 15, wherein the characteristic map is selected according to a selected driving mode of the motor vehicle.

18. The method according to claim 14, wherein a constant deceleration is assumed in order to estimate the deceleration.

19. The method according to claim 14, wherein a predefined deceleration function is used for the deceleration.

20. The method according to claim 14, wherein the distance to the start of the speed limit area is ascertained using map data and/or sensor data and/or cloud data.

21. The method according to claim 14, wherein the speed limit value is ascertained on based on legally prescribed limit values and/or road-section-dependent limit values.

22. The method according to claim 21, wherein the speed limit value is ascertained using map data and/or camera data and/or cloud data.

23. The method according to claim 21, further comprising:
ascertaining the maximum end speed based on the current motor vehicle speed and the speed increase, and after the maximum end speed has been ascertained, the motor vehicle is accelerated from the current speed to the maximum end speed and then decelerated to the speed limit value until the start of the speed limit area.

24. A control unit for a driver assistance system for controlling a longitudinal control of a motor vehicle, comprising:
a computing unit configured to ascertaining a maximum end speed of a motor vehicle before a start of a speed limit area, the computing unit configured to:
ascertain a current motor vehicle speed, a speed limit value of an upcoming speed limit area, and a distance to the start of the speed limit area,
estimate a time to the speed limit area based on the current motor vehicle speed, the speed limit, and the distance to the start of the speed limit area,
determine a speed increase with respect to the current motor vehicle speed, the increase being dependent on the time to the speed limit area,
estimate a deceleration so that, based on the current motor vehicle speed, the speed increase, and the distance to the start of the speed limit area, the speed limit value is present at the start of the speed limit area, and
reduce the ascertained speed increase when the estimated deceleration is greater than a deceleration limit value

25. A non-transitory machine-readable data carrier on which is stored a computer program for ascertaining a maximum end speed of a motor vehicle before a start of a speed limit area, the computer program, when executed by a computer, causing the computer to perform the following steps:
ascertaining a current motor vehicle speed, a speed limit value of an upcoming speed limit area, and a distance to the start of the speed limit area;
estimating a time to the speed limit area based on the current motor vehicle speed, the speed limit, and the distance to the start of the speed limit area;
determining a speed increase with respect to the current motor vehicle speed, the increase being dependent on the time to the speed limit area;
estimating a deceleration so that, based on the current motor vehicle speed, the speed increase, and the distance to the start of the speed limit area, the speed limit value is present at the start of the speed limit area; and
reducing the ascertained speed increase when the estimated deceleration is greater than a deceleration limit value.
